(19) United States
(12) Patent Application Publication
(10) Pub. No.: US 2024/0397082 A1
(43) Pub. Date: Nov. 28, 2024

(54) IMAGE ENCODING/DECODING METHOD AND DEVICE

(71) Applicant: Samsung Electronics Co., Ltd., Suwon-si (KR)

(72) Inventors: Kiwon YOO, Suwon-si (KR); Doohyun KIM, Suwon-si (KR); Bumkwi CHOI, Suwon-si (KR)

(73) Assignee: Samsung Electronics Co., Ltd., Suwon-si (KR)

(21) Appl. No.: 18/795,896

(22) Filed: Aug. 6, 2024

Related U.S. Application Data
(63) Continuation of application No. PCT/KR2023/002103, filed on Feb. 14, 2023.

(30) Foreign Application Priority Data
Apr. 15, 2022 (KR) 10-2022-0046826

(51) Int. Cl. H04N 19/573; H04N 19/105; H04N 19/139; H04N 19/172; H04N 19/176; H04N 19/52

(52) U.S. Cl. CPC H04N 19/573; H04N 19/105; H04N 19/139; H04N 19/172; H04N 19/176; H04N 19/52

(57) ABSTRACT

An image providing device, including: at least one processor configured to implement: an image receiver configured to receive an image signal; an image encoder configured to encode the image signal into a bitstream based on inter prediction information for a current block of the image signal, wherein the inter prediction information includes at least one of first motion prediction information including a first motion vector, and second motion prediction information including a second motion vector; and an image provider configured to output the encoded bitstream to an image receiving device, wherein the image encoder is further configured to estimate the first motion vector for a first reference picture, obtain a second motion vector candidate list from at least one neighboring block of the current block, and obtain the second motion vector based on the second motion vector candidate list

### CROSS-REFERENCE TO RELATED APPLICATIONS

This application is a continuation of International Application No. PCT/KR2023/002103, filed on Feb. 14, 2023, in the Korean Intellectual Property Receiving Office, which is based on and claims priority to Korean Patent Application Number 10-2022-0046826 filed on Apr. 15, 2022, the disclosures of which are incorporated by reference herein in their entireties.

### BACKGROUND

### 1. Field

The disclosure relates to a method and a device for encoding and/or decoding an image signal using inter prediction information, and more particularly, to obtaining a second motion vector, based on a motion vector candidate list obtained from at least one neighboring block of a current block of the image signal and a pre-estimated first motion vector, and using the second motion vector as motion prediction information for the current block.

### 2. Description of Related Art

Demand for high-resolution and high-quality images such as high-definition (HD) images and ultra-high definition (UHD) images is increasing. As a resolution and a quality of image data increases, the data amount of data increases as well, and thus, costs for transmission and storage of data may increase when the image video data is transferred over a network or stored using a storage medium. In order to solve these problems caused by high resolution and high quality of image data, an improved image encoding/decoding technology with high efficiency and low latency is desirable.

In encoding and/or decoding images, when using an inter-compression technique of compressing a current picture of an image signal by using spatiotemporal correlations with neighboring pictures as inter prediction information, compression performance may be enhanced by encoding the image signal with bi-directional motion prediction. However, this may involve using at least two motion information predictions, which may increase the amount of computation, implementation load, and power consumption.

### SUMMARY

Provided is an image encoding/decoding method and device capable of performing a bi-directional motion prediction without increasing the amount of computation or additionally implementing a motion estimation module, and therefore improving image compression performance, in an inter-compression technology for compressing a current block of an image signal.

Provided is a method and device for encoding/decoding an image signal by obtaining a second motion vector from a motion vector candidate list obtained from at least one neighboring block of a current block of the image signal, based on a pre-estimated first motion vector, and using the second motion vector as motion prediction information for the current block.

In accordance with an aspect of the disclosure, an image providing device includes: at least one processor configured to implement: an image receiver configured to receive an image signal; an image encoder configured to encode the image signal into a bitstream based on inter prediction information for a current block of the image signal, wherein the inter prediction information includes at least one of first motion prediction information including a first motion vector, and second motion prediction information including a second motion vector; and an image provider configured to output the encoded bitstream to an image receiving device, wherein the image encoder is further configured to estimate the first motion vector for a first reference picture, obtain a second motion vector candidate list from at least one neighboring block of the current block, and obtain the second motion vector based on the second motion vector candidate list.

The image encoder may be further configured to obtain the second motion vector based on determining that the first reference picture is a reference picture of the second motion vector, and that a difference value between the second motion vector and the first motion vector is a largest difference value from among a plurality of difference values corresponding to a plurality of second motion vector candidates included in the second motion vector candidate list.

The first motion prediction information may further include a first reference picture identifier and the first motion vector, and the second motion prediction information may further include the first reference picture identifier and the second motion vector.

The at least one neighboring block may include at least one of a spatial neighboring block of the current block and a temporal neighboring block of the current block.

The spatial neighboring block may be at a position including at least one of a left side of the current block, an upper side of the current block, a lower left corner of the current block, an upper left corner of the current block, and an upper right corner of the current block, and

the temporal neighboring block may be included in a collocated picture that is different from a current picture including the current block and is decoded before the current block temporally.

The image signal may include a real-time encoded image including at least one of a screen mirroring image, a video conference image, and a game image.

The image providing device may further include a communication interface configured to transmit and receive data over a network, and the image provider may be further configured to transmit the encoded bitstream to the image receiving device using the communication interface.

In accordance with an aspect of the disclosure, an image providing method includes: receiving an image signal; encoding the image signal into a bitstream based on inter prediction information for a current block of the image signal, wherein the inter prediction information may include at least one of first motion prediction information including a first motion vector, and second motion prediction information including a second motion vector; and outputting the encoded bitstream to an image receiving device, wherein the encoding includes: estimating the first motion vector for a first reference picture, obtaining a second motion vector candidate list from at least one neighboring block of the current block, and obtaining the second motion vector based on the second motion vector candidate list.

The second motion vector may be obtained based on determining that the first reference picture is a reference picture of the second motion vector, and that a difference value between the second motion vector and the first motion vector is a largest difference value from among a plurality of difference values corresponding to a plurality of second motion vector candidates included in the second motion vector candidate list.

The first motion prediction information may further include a first reference picture identifier and the first motion vector, and the second motion prediction information may further include the first reference picture identifier and the second motion vector.

The at least one neighboring block may include at least one of a spatial neighboring block of the current block and a temporal neighboring block of the current block.

The spatial neighboring block may be at a position including at least one of a left side of the current block, an upper side of the current block, a lower left corner of the current block, an upper left corner of the current block, and an upper right corner of the current block, and the temporal neighboring block may be included in a collocated picture that is different from a current picture including the current block and is decoded before the current block temporally.

The image signal may include a real-time encoded image including at least one of a screen mirroring image, a video conference image, and a game image.

The image providing method may further include transmitting and receiving data over a network; wherein the outputting of the encoded bitstream may include transmitting the encoded bitstream to the image receiving device through the network.

### BRIEF DESCRIPTION OF DRAWINGS

FIG. 1 is a diagram schematically illustrating a system for encoding/decoding an image signal according to an embodiment of the disclosure.

FIG. 2 is a schematic block diagram of an image providing device and an image receiving device according to an embodiment of the disclosure.

FIG. 3 is a schematic block diagram of an image encoder of an image providing device according to an embodiment of the disclosure.

FIG. 4 is a schematic block diagram of an image decoder of an image receiving device according to an embodiment of the disclosure.

FIG. 5 is a schematic flowchart of an image encoding method according to an embodiment of the disclosure.

FIG. 6 is a diagram illustrating split blocks of a picture according to an embodiment of the disclosure.

FIG. 7 is a diagram illustrating at least one neighboring block of a current block for obtaining a motion vector candidate list, according to an embodiment of the disclosure.

### DETAILED DESCRIPTION

Hereinafter, various embodiments of the disclosure are described in detail with reference to the accompanying drawings. However, the disclosure may be implemented in various different forms and is not limited to the embodiments described herein. In conjunction with the description of the drawings, the same or similar components may be indicated by the same or similar reference numerals. Further, in the drawings and their related description, descriptions of well-known functions and configurations may be omitted for clarity and brevity.

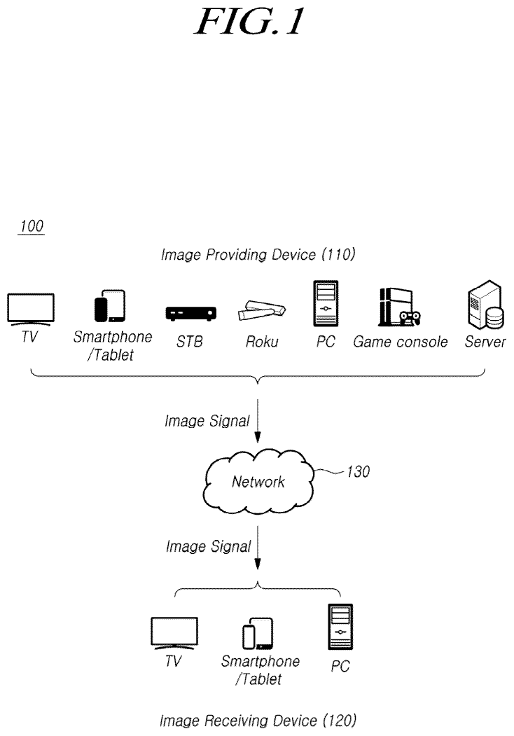

FIG. 1 is a diagram schematically illustrating a system for encoding/decoding an image signal according to an embodiment of the disclosure. In embodiments, encoding/decoding may refer to at least one of encoding and decoding.

Referring to FIG. 1, a system 100 for encoding/decoding an image signal may include an image providing device 110 and an image receiving device 120.

The image providing device 110 may provide an image signal including a video and an image to the image receiving device 120 over a communication network 130 in a streaming form, and the image receiving device 120 may receive and reproduce the image signal from the image providing device 110. The image providing device 110 may encode an image signal by removing and compressing redundant information in the image signal to the extent that it is not visually detected. The image providing device 110 may efficiently store, transmit, and manage an image signal, encoding the image signal in a predetermined range of compression rate. The image signal may include a real-time encoded image inclusive of a screen mirroring image, a video conference image, a game image, or the like.

The image providing device 110 may include various image source devices such as a television (TV), a personal computer (PC), a smartphone, a tablet, a set-top box, a game console, a server, and the like, and the image receiving device 120 may include a variety of image reproducing devices such as a TV, a smartphone, a tablet, a PC, etc. It will be apparent to those having ordinary skill in the art that both the image providing device 110 and the image receiving device 120 are not limited to a specific type of electronic device.

The image providing device 110 and the image receiving device 120 may transmit and/or receive image signals over the network 130. According to various embodiments, the network 130 connecting the image providing device 110 and the image receiving device 120 to each other may include a short-range communication network such as wireless-fidelity (Wi-Fi), and a long-range communication network such as a cellular network, a next-generation communication network, Internet, or a computer network (e.g., local area network (LAN) or wide area network (WAN)), and may perform communications based on an internet protocol (IP) communication protocol. The cellular network may include Global System for Mobile Communications (GSM), Enhanced Data GSM Environment (EDGE), Code Division Multiple Access (CDMA), Time Division Multiplexing Access (TDMA), 5th Generation (5G), Long Term Evolution (LTE), LTE Advanced (LTE-A) and the like. The network 130 may include connection of network elements such as a hub, a bridge, a router, a switch, and a gateway. The network 130 may include one or more connected networks, such as e.g., a multi-network environment, including a public network such as the Internet and a private network such as an enterprise private network. Access to the network 130 may be provided through one or more wired or wireless access networks. Furthermore, the network 130 may support an Internet of Things (IoT) network for exchanging and processing information between distributed components such as things.

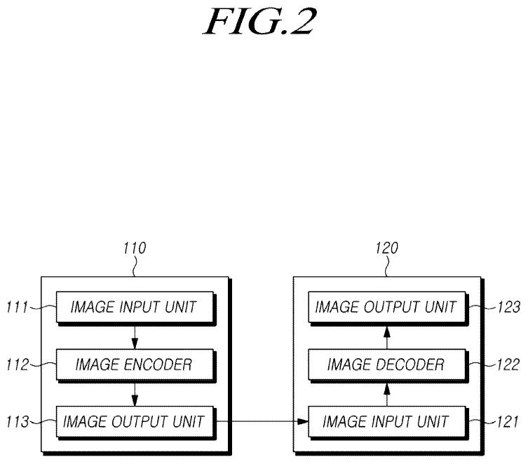

FIG. 2 is a schematic block diagram of an image providing device and an image receiving device according to an embodiment of the disclosure.

Referring to FIG. 2, the image providing device 110 may include an image input unit 111, an image encoder 112, and an image output unit 113. The image providing device 110 may further include a memory, a processor, and a communication interface. The image providing device 110 may further include additional components other than the components discussed above, or may omit at least one of the components.

According to an embodiment, the memory may store a program including one or more instructions or data, such as configuration information. The memory may include a volatile memory, a non-volatile memory, or a combination of a volatile memory and a non-volatile memory. The memory may provide stored data according to a request of the processor.

According to an embodiment, the communication interface may provide an interface for communication with other systems or devices. The communication interface may include a network interface card or a wireless transceiver that enables communication over the network 130. The communication interface may perform signal processing for accessing a wireless network. The wireless network may include, for example, at least one of a wireless LAN and a cellular network (e.g., LTE).

According to an embodiment, the processor may be electrically connected to the communication interface and the memory, and may perform operations or data processing related to control and/or communication of at least one other component of the image providing device 110, using a program stored in the memory. The processor may execute at least one instruction associated with the image input unit 111, the image encoder 112, and the image output unit 113. The processor may include at least one of a central processing unit (CPU), a graphics processing unit (GPU), a micro controller unit (MCU), a sensor hub, a supplementary processor, a communication processor, an application processor, an application specific integrated circuit (ASIC), and a field programmable gate array (FPGA), and may have a plurality of cores.

According to an embodiment, the image input unit 111 may receive an image signal. The image signal may be received from the outside of the image providing device 110 or may be pre-stored in the image providing device 110. The image input unit 111 may control the communication interface to receive an image signal from the outside in a wired or wireless mode.

According to an embodiment, the image encoder 112 may encode the image signal input by the image input unit 111. The image encoder 112 may perform a series of processing such as prediction, transformation, quantization, and the like for improving efficiency of signal compression and encoding. The image encoder 112 may provide the encoded image signal (or for example encoded data) to the image output unit 113 in the form of a bitstream.

According to an embodiment, the image output unit 113 may control the communication interface to transmit the encoded image signal to the image receiving device 120 via the network 130. In some embodiments, the image output unit 113 may transfer the encoded image signal to the image receiving device 120 through a digital storage medium. The digital storage medium may include various storage media such as a universal serial bus (USB), secure digital (SD), compact disc (CD), digital versatile disk (DVD), Blu-ray, hard disk drive (HDD), solid state drive (SSD) and so on.

The image receiving device 120 may include an image input unit 121, an image decoder 122, and an image output unit 123. The image output unit 123 may include a display, and the display may be configured as a separate device or an external component. The image receiving device 120 may further include a memory, a processor, and a communication interface. The image receiving device 120 may further include additional components other than the illustrated components, or may omit at least one of the illustrated components.

According to an embodiment, the memory may store data such as a program including one or more instructions or configuration information. The memory may include a volatile memory, a non-volatile memory, or a combination of a volatile memory and a non-volatile memory. The memory may provide stored data according to a request of the processor.

According to an embodiment, the communication interface may provide an interface for communication with other systems or devices. The communication interface may include a network interface card or a wireless transceiver that enables communication over the network 130. The communication interface may perform signal processing for accessing a wireless network. The wireless network may include, for example, at least one of a wireless LAN and a cellular network (e.g., LTE).

According to an embodiment, the processor may be electrically connected to the communication interface and the memory, and may use a program stored in the memory to perform operations or data processing based on the control and/or communication of at least one other component of the image receiving device 120. The processor may execute at least one instruction associated with the image input unit 121, the image decoder 122, and the image output unit 123. The processor may include at least one of a CPU, a GPU, an MCU, a sensor hub, a supplementary processor, a communication processor, an application processor, an ASIC, and an FPGA, and may have a plurality of cores.

According to an embodiment, the image input unit 121 may receive an image signal. The image input unit 121 may control the communication interface to receive the image signal from the image providing device 110 via the network 130. The image input unit 121 may control the communication interface to receive the image signal from the image providing device 110 in a wired or wireless mode. In some embodiments, the image input unit 121 may obtain the image signal from the image providing device 110 with a digital storage medium. The digital storage medium may include various storage media such as USB, SD, CD, DVD, Blu-ray, HDD, SSD and the like.

According to an embodiment, the image decoder 122 may decode an image signal by performing a series of signal processing procedures, such as inverse quantization, inverse transformation, and prediction corresponding to an operation of the image encoder 112.

According to an embodiment, the image output unit 123 may render the decoded image signal. The rendered image signal may be displayed through the display.

The image providing device 110 and the image receiving device 120 may further include additional components other than the illustrated components, or at least one of the illustrated components may be omitted therefrom.

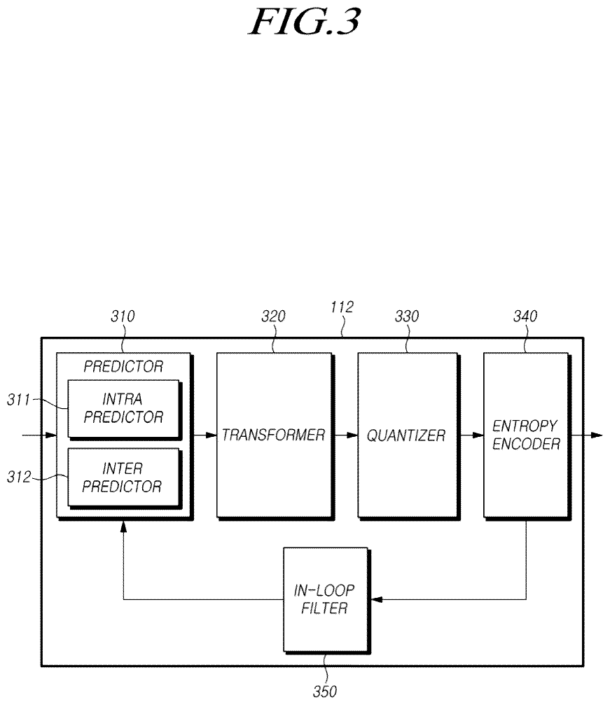

FIG. 3 is a schematic block diagram of an image encoder of an image providing device according to an embodiment of the disclosure.

Referring to FIG. 3, the image encoder 112 may include a predictor 310, a transformer 320, a quantizer 330, an entropy encoder 340, and an in-loop filter 350. The image encoder 112 may further include additional components other than the components illustrated above, or at least one of the illustrated components may be omitted therefrom. All or at least some of a plurality of components making up the image encoder 112 may be implemented as one hardware component (e.g., an encoder or a processor) according to an embodiment. Further, the image encoder 112 may further include a memory. The memory may be implemented with a digital storage medium and may include a buffer for buffering a picture decoded during encoding.

According to an embodiment, the image encoder 112 may split an input image signal (or for example a picture/frame) into one or more processing units (PUs). For example, the processing unit may be referred to as a coding unit (CU). The coding unit may be obtained by recursively dividing a coding tree unit (CTU) or a largest coding unit (LCU) based on at least one of a quad-tree (QT) structure, a binary-tree (BT) structure, and a ternary-tree (TT) structure. For example, one coding unit may be divided into a plurality of coding units of a deeper depth based on a QT structure, a BT structure, and/or a TT structure. An encoding procedure according to the disclosure may be performed based on a final coding unit that is no longer split. The encoding procedure may include procedures such as e.g., prediction, transformation, and quantization, examples of which are described below. As another example, the processing unit of the encoding procedure may be a predictor (or for example a prediction unit (PU)) or a transformer (or transform unit (TU)). The predictor and the transformer may be divided or partitioned from the final coding unit, respectively. The predictor may be a unit of sample prediction, and the transformer may be a unit for deriving a transform coefficient and/or a unit for deriving a residual signal from the transform coefficient. Throughout the disclosure, a pixel may mean a minimum unit configuring one picture (or for example an\image). Further, a sample may be used as a term corresponding to a pixel, and may represent a pixel or a value of a pixel.

According to an embodiment, the predictor 310 may perform prediction on a current block (e.g., a block to be processed) and generate a predicted block including prediction samples for the current block. The predictor 310 may determine whether an intra prediction is applied or an inter prediction is applied in units of the current block or CU. The predictor 310 may generate various information about the prediction of the current block to transmit the information to the entropy encoder 340. The information about the prediction may be encoded by the entropy encoder 340 and output in the form of a bitstream.

According to an embodiment, an intra predictor 311 may predict the current block by referring to samples in the current picture. The referenced samples may be located in neighbor of the current block or away therefrom, according to an intra prediction mode and/or an intra prediction scheme.

According to an embodiment, the inter predictor 312 may derive a predicted block for the current block, based on a reference block specified by a motion vector on a reference picture. In this case, in order to reduce the amount of motion information transmitted in the inter prediction mode, the motion prediction information may be predicted in units of a block, a sub-block, or a sample, based on correlation of the motion information between the neighboring block and the current block. The motion prediction information may include a reference picture identifier (or for example an index) and a motion vector (MV). The motion prediction information may further include information about inter prediction direction (e.g., L0 direction, L1 direction, etc.).

According to an embodiment, the inter predictor 312 may derive a predicted block for the current block, using at least one piece of motion prediction information as inter prediction information. For example, the inter predictor 312 may derive the predicted block for the current block, using at least one of first motion prediction information including a first motion vector MBL0 and second motion prediction information including a second motion vector MBL1, as the inter prediction information for the current block of an image signal. The inter predictor 312 may estimate the first motion vector MBL0 for a first reference picture. The inter predictor 312 may obtain a second motion vector candidate list from at least one neighboring block of the current block, and may obtain the second motion vector based on the second motion vector candidate list.

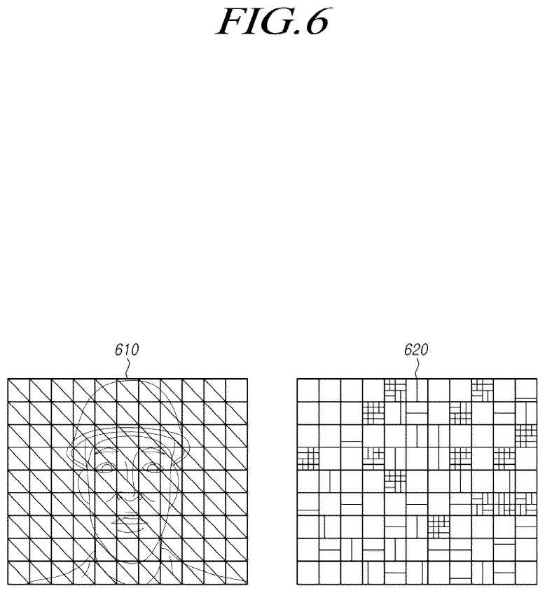

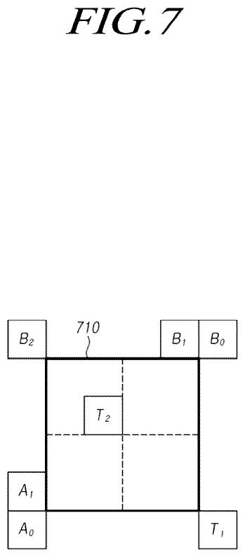

According to an embodiment, the at least one neighboring block may include at least one spatial neighboring block present in a current picture and at least one temporal neighboring block present in a reference picture. The reference picture including the temporal neighboring block may be referred to as a collocated picture (colPic), a col picture, or the like. The temporal neighboring block having the same location as the current block on the col picture may be referred to as a collocated reference block, a col block, a collocated CU (colCU), or the like. The split blocks of the picture and at least one neighboring block of the current block will be described later with reference to FIGS. 6 and 7.

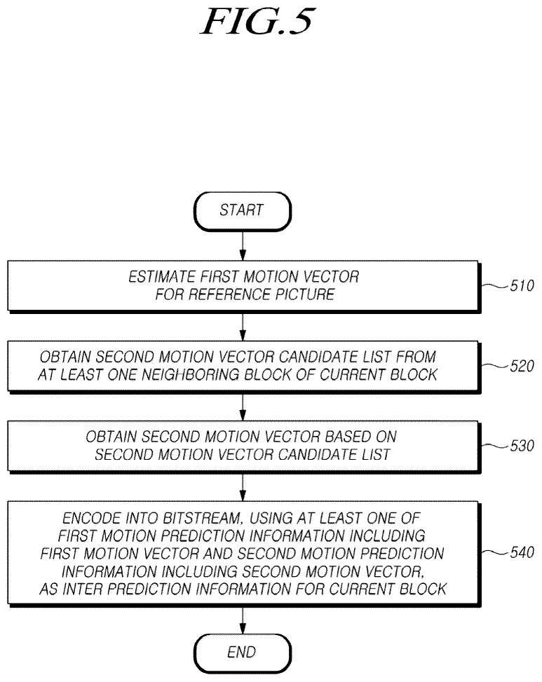

According to an embodiment, the inter predictor 312 may obtain, as the second motion vector, a motion vector of which a reference picture is the same as the first reference picture and a difference value from the first motion vector is greatest, from among the second motion vector candidate list. An example in which the inter predictor 312 obtains the second motion vector will be described in detail below with reference to FIG. 5, Table 1, and Table 2.

A prediction signal generated by the predictor 310 may be used to generate a reconstruction signal or to generate a residual signal. The residual signal (or for example a residual block) generated by subtracting the prediction signal (or for example a predicted block) from an input image signal (or for example an original block) may be transmitted to the transformer 320.

According to an embodiment, the transformer 320 may generate transform coefficients by applying a transform scheme to a residual signal. For example, the transform scheme may include at least one of a discrete cosine transform (DCT), a discrete sine transform (DST), a Karhunen-Loeve transform (KLT), a graph-based transform (GBT), and a conditionally non-linear transform (CNT). Here, the GBT may refer to a transformation obtained from a graphic representation of the relationship information between pixels. The CNT may refer to a transformation that generates a prediction signal using all previously reconstructed pixels and is obtained based on the generated prediction signal. The transformation process may apply to a pixel block having the same size as a square, or may also apply to a block having a variable size other than a square.

According to an embodiment, the quantizer 330 may quantize the transform coefficients and transmit the quantized transform coefficients to the entropy encoder 340. The entropy encoder 340 may encode a quantized signal (information about quantized transform coefficients) and output the encoded signal in a bitstream. The information about the quantized transform coefficients may be referred to as residual information. The quantizer 330 may rearrange the quantized transform coefficients of a block form into a one-dimensional vector form based on a coefficient scan order, and may generate information about the quantized transform coefficients based on the quantized transform coefficients in the form of one-dimensional vector. According to an embodiment, the entropy encoder 340 may perform various encoding schemes such as e.g., exponential Golomb, context-adaptive variable length coding (CAVLC), and context-adaptive binary arithmetic coding (CABAC).

According to an embodiment, an in-loop filter 350 may reconstruct compression degradation by applying filtering to a resulting image from the encoding process. For example, the in-loop filter 350 may apply various filtering schemes to a reconstructed picture to generate a modified reconstructed picture. The various filtering schemes may include, for example, deblocking filtering, a sample adaptive offset, an adaptive loop filter, a bilateral filter, and the like. The modified reconstructed picture may be stored in the memory and used as a reference picture in the predictor 310.

The memory may store motion prediction information of a block in which motion prediction information within a current picture was derived (or for example encoded) and/or motion prediction information of blocks within a picture already reconstructed. The stored motion prediction information may be transmitted to the inter predictor 312 for using as motion prediction information of a spatial neighboring block or motion prediction information of a temporal neighboring block. The memory may store reconstructed samples of reconstructed blocks in the current picture, and the stored reconstructed samples may be transferred to the intra predictor 311.

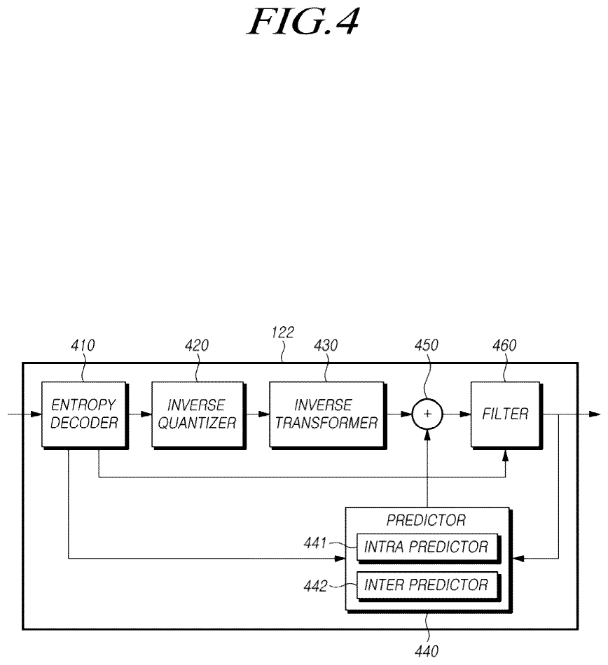

FIG. 4 is a schematic block diagram of an image decoder of an image receiving device according to an embodiment of the disclosure.

Referring to FIG. 4, the image decoder 122 may include an entropy decoder 410, an inverse quantizer 420, an inverse transformer 430, a predictor 440, an adder 450, and a filter 460. The image decoder 122 may further include additional components other than the components illustrated above, or at least one of the illustrated components may be omitted. All or at least some of a plurality of components configuring the image decoder 122 may be implemented as one hardware component (e.g., a decoder or a processor) according to an embodiment. Further, the image decoder 122 may further include a memory. The memory may be implemented with a digital storage medium and may include a buffer for buffering a decoded picture.

The image decoder 122 may reconstruct an image signal, performing a process corresponding to the process performed by the image encoder 112 described above with reference to FIG. 3. For example, the image decoder 122 may perform decoding by using a processing unit applied by the image encoder 112. Thus, the decoding processing unit may be, for example, a coding unit. The coding unit may be a coding tree unit or may be obtained by dividing a maximum coding unit.

According to an embodiment, the entropy decoder 410 may parse a bitstream to derive information necessary for image reconstruction (or for example picture reconstruction). For example, the entropy decoder 410 may decode information in the bitstream based on a decoding method such as exponential Golomb, CAVLC, CABAC, or the like, and output information about quantized transform coefficients of residuals required for the image reconstruction. Among the information decoded by the entropy decoder 410, information on prediction may be provided to the predictor 440, and a residual value in which entropy decoding is performed by the entropy decoder 410, that is, quantized transform coefficients and related parameter information may be input to the inverse quantizer 420. Further, information on filtering of the information decoded by the entropy decoder 410 may be fed to the filter 460.

According to an embodiment, the inverse quantizer 420 may inversely quantize quantized transform coefficients to output the transform coefficients. The inverse quantizer 420 may rearrange the quantized transform coefficients into a two-dimensional block form. In this case, the rearrangement may be performed based on a coefficient scan order performed by the image encoder 112. The inverse quantizer 420 may use a quantization parameter (e.g., quantization step size information) to perform inverse quantization on quantized transform coefficients, and obtain transform coefficients.

According to an embodiment, the inverse transformer 430 may inversely quantize the transform coefficients to obtain a residual signal (a residual block).

According to an embodiment, the predictor 440 may perform prediction on a current block and generate a predicted block including prediction samples for the current block. The predictor 440 may determine whether intra prediction is applied or inter prediction is applied to the current block, based on information on the prediction output from the entropy decoder 410, and may determine a specific intra/inter prediction mode (a prediction scheme). The intra predictor 441 may predict the current block by referring to samples in a current picture. The inter predictor 442 may derive a predicted block for the current block, based on a reference block specified by the motion vector on a reference picture. An operation of each of the intra predictor 441 and the inter predictor 442 corresponds to the operation of each of the intra predictor 311 and the inter predictor 312 of the image encoder 112.

According to an embodiment, the adder 450 may generate a reconstructed signal (reconstructed picture, reconstructed block) by adding the residual signal obtained from the inverse transformer 430 to the prediction signal (the predicted block) output from the predictor 440.

According to an embodiment, the filter 460 may improve image quality by applying filtering to the reconstructed signal. For example, the filter 460 may generate a modified reconstructed picture by applying various filtering methods to the reconstructed picture, and may store the modified reconstructed picture in the memory. The various filtering methods may include, for example, deblocking filtering, a sample adaptive offset, an adaptive loop filter, a bilateral filter, and the like. The reconstructed picture stored in the memory may be used as a reference picture by the predictor 440. The memory may store motion prediction information of a block from which motion prediction information in a current picture is derived (or for example decoded) and/or motion prediction information of blocks in a picture already reconstructed. The stored motion prediction information may be transmitted to the inter predictor 442 for utilizing as motion prediction information of a spatial neighboring block or motion prediction information of a temporal neighboring block. The memory may store reconstructed samples of reconstructed blocks within the current picture, and the stored reconstructed samples may be delivered to the intra predictor 441.

FIG. 5 is a schematic flowchart of an image encoding method according to an embodiment of the disclosure.

FIG. 6 illustrates split blocks of a picture according to an embodiment of the disclosure.

FIG. 7 illustrates at least one neighboring block of a current block for obtaining a motion vector candidate list, according to an embodiment of the disclosure.

According to an embodiment of the disclosure, the image providing device 110 may receive an image signal.

Referring to FIG. 6, the image providing device 110 may split and encode an input image signal (or for example a picture/frame) into one or more processing units (PUs) or blocks. In the illustrated example, an input picture (e.g., a picture of 352×288 size) may be divided into square blocks as shown in example 610. In the illustrated example, the square block may have various sizes such as 16×16, 32×32, 64×64, 128×128 or the like, but it will be apparent to those skilled in the art that the square block is not limited to such a specific size. Each square block may be recursively divided into square or non-square small blocks as shown in example 620.

Referring to FIG. 5, at operation 510 according to an embodiment, the image providing device 110 may search for a reference block most similar to a current block to be encoded, in a first reference picture temporally already decoded, and may estimate first motion prediction information for the current block from the reference block. The first motion prediction information may include a first reference picture identifier (or for example a reference picture index) RefIdxL0 and a first motion vector MBL0 for the reference block. The motion vector may include a direction component and a size component for the current block. For example, the searched reference block may have a value of RefIdxL0=0, MVL0=(5,−4).

At operation 520, the image providing device 110 may obtain a second motion vector candidate list from at least one neighboring block of the current block. The at least one neighboring block may include at least one of spatial neighboring block and temporal neighboring block of the current block. When configuring the second motion vector candidate list, the second motion vector candidate list may include at least one of a motion vector in the L0 direction and a motion vector in the L1 direction.

The spatial neighboring block may be a neighboring block at a location including at least one of left side, upper side, lower left corner, upper left corner, and upper right corner of a current block. The temporal neighboring block may be at least one neighboring block located in a collocated picture (col picture) that is different from the current picture in which the current block is located and has already been decoded temporally. It will be apparent to one of ordinary skill in the art that the image providing device 110 may configure the second motion vector candidate list in various ways, such as selecting or excluding a specific candidate block from the spatial neighboring block and the temporal neighboring block. FIG. 7 illustrates by way of example seven neighboring blocks including left neighboring blocks (A0, A1), upper neighboring blocks (B0, B1, B2), and temporal neighboring blocks (T1, T2) with respect to a current block 710. In the illustrated example, the image providing device 110 may configure all those seven neighboring blocks as a second motion vector candidate list. In some embodiments, the image providing device 110 may configure the final three of second motion vector candidate lists by selecting a respective one of the left neighboring blocks, the upper neighboring blocks, and the temporal neighboring blocks.

Referring back to FIG. 5, at operation 530, the image providing device 110 may obtain a second motion vector, based on the second motion vector candidate list. Referring to the conditions of Table 1 below, the image providing device 110 may obtain, as the second motion vector, a motion vector of which a reference picture is the same as the first reference picture and a difference value from the first motion vector is greatest, from the second motion vector candidate list.

TABLE 1

(RefIdxL0 == RefidxL1) && ArgMax|MVL0 −- MVL1|

Table 2 below shows the condition values in a process of obtaining the second motion vector, based on the second motion vector candidate list, in case where the image providing device 110 configures the second motion vector candidate list, including motion vectors MBL1 in the L1 direction of neighboring blocks corresponding to A0, A1, B0, B1, and T1 from among the neighboring blocks of the current block 710 illustrated in FIG. 7.

TABLE 2

| | RefIdxL0 == | |
|---|---|---|
| MVL1 Candidate List | RefIdxL1 | \|MVL0 − MVL1\| |
| A0 Block (RefIdx = 0, MV = (5, −2)) | TRUE | 2 |
| A1 Block (RefIdx = 0, MV = (5, −3)) | TRUE | 1 |
| B0 Block (RefIdx = 1, MV = (10, −5)) | FALSE | 6 |
| B1 Block (RefIdx = 0, MV = (−3, −2)) | TRUE | 10 |
| T1 Block (RefIdx = 1, MV = (9, 3)) | FALSE | 11 |

The first motion prediction information of the current block may be RefIdxL0=0, MVL0=(5,−4), and the second motion vector candidate list may include motion prediction information of blocks A0, A1, B0, B1, and T1. As a result of determining whether a reference picture is the same between the current block and neighboring blocks corresponding to the second motion vector candidate list, and calculating a difference in distance from the first motion vector (MVL0), the image providing device 110 may determine the motion vector of the block B1 as the second motion vector (MVL1). In the example described above with reference to Table 2, the difference in distance between MVL0 and MVL1 was calculated as the sum of the distances of the same directional component (e.g., the absolute value of the difference value of the size components), but it will be apparent to those skilled in the art that the method of calculating the difference value between vectors is not limited thereto.

At operation 540, the image providing device 110 may encode the current block as a bitstream, using at least one of the first motion prediction information including the first motion vector and the second motion prediction information including the second motion vector, as inter prediction information for the current block. When determining, as a final mode for prediction of the current block, a mode in which at least one of the first motion prediction information and the second motion prediction information is used as inter prediction information for the current block, by comparison with other intra/inter prediction modes, the image providing device 110 may encode the current block as a bitstream, based on the determined mode. The first motion prediction information may include the first reference picture identifier and the first motion vector, and the second motion prediction information may include the first reference picture identifier and the second motion vector.

According to an embodiment, the image providing device 110 may output an image signal including the encoded current block to the image receiving device 120.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. For example, a component expressed in the singular is to be understood as including a plurality of components unless the context clearly indicates only a singular meaning. As used in the disclosure, the term “and/or” is to be understood to encompass all possible combinations of one or more of the enumerated items. As used in the disclosure, the terms “comprise”, “have”, “include”, “consist of”, and the like are intended only to designate the presence of features, components, parts, or combinations thereof described in the disclosure, and the use of such terms is not intended to exclude the possibility of presence or addition of one or more other features, components, parts, or combinations thereof. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order).

As used in connection with various embodiments of the disclosure, the term “˜portion” or “˜module” may include a unit implemented in hardware, software, or firmware, and may interchangeably be used with other terms, for example, “logic”, “logic block”, “part”, or “circuit”. Such a “˜portion” or “˜module” may be a single integral component, or a minimum unit or a part of the component, adapted to perform one or more functions. For example, according to an embodiment, the “˜portion” or “˜module” may be implemented in the form of an application-specific integrated circuit (ASIC).

As used in connection with various embodiments of the disclosure, the term “in case where (or that)˜” may be interpreted to mean “when˜”, “if ˜”, “in response to determining˜”, or “in response to detecting˜”, depending on the context. Similarly, the phrases “when it is determined that ˜” or “when it is detected that ˜” may be interpreted to mean “when determining˜”, “in response to determining˜”, “when detecting˜” or “in response to detecting˜”, depending on the context.

The program executed by the image providing device 110 and the image receiving device 120 as described in the disclosure may be implemented as a hardware component, a software component, and/or a combination of the hardware component and the software component. The program may be performed by any system capable of executing computer-readable instructions.

Software may include a computer program, a code, an instruction, or a combination of one or more of them, and may configure a processing unit to operate as desired or instruct the processing unit independently or collectively. The software may be implemented as a computer program including instructions stored in a computer-readable storage medium. The computer-readable storage media may include, for example, magnetic storage media (e.g., read-only memory (ROM), random-access memory (RAM), a floppy disk, hard disk, etc.), optical readable media (e.g., compact disc read only memory (CD-ROM), DVD) and the like. The computer-readable storage media may be distributed over networked computer systems, so that computer-readable codes may be stored and executed in a distributed manner. The computer program product may be distributed (e.g., downloaded or uploaded) directly or online through an application store (e.g., PlayStore™) or between two user devices (e.g., smartphones). If distributed online, at least part of the computer program product may be at least temporarily stored or generated in a machine-readable storage medium, such as memories of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An image providing device, comprising:
at least one processor configured to implement:
an image receiver configured to receive an image signal;
an image encoder configured to encode the image signal into a bitstream based on inter prediction information for a current block of the image signal, wherein the inter prediction information includes at least one of first motion prediction information comprising a first motion vector, and second motion prediction information comprising a second motion vector; and
an image provider configured to output the encoded bitstream to an image receiving device,
wherein the image encoder is further configured to estimate the first motion vector for a first reference picture, obtain a second motion vector candidate list from at least one neighboring block of the current block, and obtain the second motion vector based on the second motion vector candidate list.

2. The image providing device of claim 1, wherein the image encoder is further configured to obtain the second motion vector based on determining that the first reference picture is a reference picture of the second motion vector, and that a difference value between the second motion vector and the first motion vector is a largest difference value from among a plurality of difference values corresponding to a plurality of second motion vector candidates included in the second motion vector candidate list.

3. The image providing device of claim 2, wherein the first motion prediction information further comprises a first reference picture identifier and the first motion vector, and
wherein the second motion prediction information further comprises the first reference picture identifier and the second motion vector.

4. The image providing device of claim 1, wherein the at least one neighboring block comprises at least one of a spatial neighboring block of the current block and a temporal neighboring block of the current block.

5. The image providing device of claim 4,
wherein the spatial neighboring block is at a position including at least one of a left side of the current block, an upper side of the current block, a lower left corner of the current block, an upper left corner of the current block, and an upper right corner of the current block, and
wherein the temporal neighboring block is included in a collocated picture that is different from a current picture comprising the current block and is decoded before the current block temporally.

6. The image providing device of claim 1, wherein the image signal comprises a real-time encoded image including at least one of a screen mirroring image, a video conference image, and a game image.

7. The image providing device of claim 1, further comprising a communication interface configured to transmit and receive data over a network,
wherein the image provider is further configured to transmit the encoded bitstream to the image receiving device using the communication interface.

8. An image providing method, comprising:
receiving an image signal;
encoding the image signal into a bitstream based on inter prediction information for a current block of the image signal, wherein the inter prediction information comprises at least one of first motion prediction information including a first motion vector, and second motion prediction information including a second motion vector; and
outputting the encoded bitstream to an image receiving device,
wherein the encoding comprises:
estimating the first motion vector for a first reference picture,
obtaining a second motion vector candidate list from at least one neighboring block of the current block, and
obtaining the second motion vector based on the second motion vector candidate list.

9. The image providing method of claim 8, wherein the second motion vector is obtained based on determining that the first reference picture is a reference picture of the second motion vector, and that a difference value between the second motion vector and the first motion vector is a largest difference value from among a plurality of difference values corresponding to a plurality of second motion vector candidates included in the second motion vector candidate list.

10. The image providing method of claim 9, wherein the first motion prediction information further comprises a first reference picture identifier and the first motion vector, and
the second motion prediction information further comprises the first reference picture identifier and the second motion vector.

11. The image providing method of claim 8, wherein the at least one neighboring block comprises at least one of a spatial neighboring block of the current block and a temporal neighboring block of the current block.

12. The image providing method of claim 11,
wherein the spatial neighboring block is at a position including at least one of a left side of the current block, an upper side of the current block, a lower left corner of the current block, an upper left corner of the current block, and an upper right corner of the current block, and
wherein the temporal neighboring block is included in a collocated picture that is different from a current picture comprising the current block and is decoded before the current block temporally.

13. The image providing method of claim 8, wherein the image signal comprises a real-time encoded image including at least one of a screen mirroring image, a video conference image, and a game image.

14. The image providing method of claim 8, further comprising transmitting and receiving data over a network;
wherein the outputting of the encoded bitstream comprises transmitting the encoded bitstream to the image receiving device through the network.
